(19) United States
(12) Patent Application Publication
(10) Pub. No.: US 2005/0193064 A1
(43) Pub. Date: Sep. 1, 2005

(54) Method and system for forwarding smtp traffic

(75) Inventor: Jeffrey A Hales, Suwanee, GA (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: coaXmedia, Inc., Duluth, GA (US)

(21) Appl. No.: 10/504,729

(22) PCT Filed: Feb. 13, 2003
(86) PCT No.: PCT/US03/04285

§ 371 Date: Aug. 13, 2004

Related U.S. Application Data
(60) Provisional application No. 60/356,617, filed on Feb. 13, 2002.

(51) Int. Cl. G06F 15/16

(52) U.S. Cl. 709/206; 709/203

(57) ABSTRACT

A method for rerouting email communications for a user (often a traveler) to send emails even when not connected. A method for routing email communications so that they will be received by email servers. The method comprises identifying the outgoing communication as an email before it reaches the wide area network (such as the Internet) (200) and routing the outgoing communication through an email server (304) affiliated with the equipment for operating the local area network (112). The email server (304) accepts the email from the local area network equipment (112) and routes the data communication to its original addressee either directly or through a proxy sever relationship with an ISP (308). After the email is routed by the email server (304), the data communication bears identifying information that it was transmitted from the email server (304) or the ISP (308) connected to the email server (304) by a proxy server relationship.

This application claims priority to U.S. Provisional Application No. 60/356,617 filed Feb. 13, 2002 for Method and System for Forwarding SMTP Traffic.

For the convenience of the reader, various acronyms and other terms used in the field of this invention are defined at the end of the specification in a glossary. Other terms used by the applicant to define the operation of the inventive system are defined throughout the specification. For the convenience of the reader, applicant has added a number of topic headings to make the internal organization of this specification apparent and to facilitate location of certain discussions. These topic headings are merely convenient aids and not limitations on the text found within that particular topic.

### BACKGROUND OF THE INVENTION

1. Technical Field

The present invention adds to the field of data communications. More particularly, the invention provides a method for successfully sending email from a user's computer, when that computer is not directly connected to the user's Internet Service Provider (ISP).

2. Problem Addressed

Due to the email related problems faced by ISP, such as unauthorized email distribution and bulk email advertising (commonly known as SPAM), many ISPs do not allow their customers to send mail unless they are connected through an authorized access points (AAPs) or points of presence (POPs). Although these users provide a valid username and password when connecting to the ISP's mail systems, the ISP will deny the user access to outbound email services. These outbound email services are typically provided using the Simple Mail Transfer Protocol (SMTP) on TCP/IP based networks. With TCP/IP based communications being a chosen standard by which information is transfer on the Internet, most email clients send email messages to a specified server's TCP port 25 (the default SMTP port).

One way to configure the user's email client/application is to directly specify an IP address associated with a particular server/host of the ISP.

An alternative path is that the server responsible for receiving a user's outgoing email is specified by a user's ISP, as a Domain Name System (DNS) resolvable hostname. DNS is used to lookup the IP address associated with a particular server/host by providing the “friendly” name of that server/host; making it unnecessary for individuals to remember a sequence of numbers that represent the logical address (IP address) assigned to that server/host. Although some ISPs utilize different servers/hosts to handle a user's inbound and outbound email traffic, and may have multiple servers/hosts to handle potentially large service areas, each of the servers/hosts have unique hostnames and IP addresses. In fact, no two Internet accessible servers/hosts are to be given the same IP address as the list of addresses is maintained and regulated. Using a unique, public address (IP address) for each server/host, makes it possible for users to access their ISPs systems from anywhere in the world.

World-wide coverage and an expanding base of services, providers and subscribers have made the Internet invaluable in reaching customers or communicating with friends. Today the most preferred method of Internet communications is electronic mail (email); with billions of email messages being sent each day. Many of these messages take form as advertisements.

Many of these email advertisements are unsolicited and unwelcome by the users that receive the unsolicited email advertisements. This type of mass produced and unwanted email has become known as SPAM. In some cases the SPAM email messages contain computer viruses. Some of the advertisements are offensive to some recipients as the advertisements try to sell services related to pornography or for sexual aids. Some advertisements are false and deceptive attempts to deceive people out of money by offering a get rich quick scheme. Other unsolicited email advertisements are merely a nuisance in that they take time to identify and delete from the user's email inbox. In aggregate, the unsolicited email adds a burden to the email and Internet systems by burdening the infrastructure needed to communicate and store emails.

In an attempt to battle these types of unsolicited email messages being delivered to customers, some ISPs restrict methods of sending email within their network domain; only allowing authorized users to send email when they are directly connected to the ISP's POPs. This is true for both ISP connections provided to employer and ISP's used for personal email.

Thus, as illustrated in FIG. 1, a traveler in a building 104 connects his/her laptop 108 to the building equipment center 112 through a connection means 116. The connection can be by phone lines, coax cable, CAT 5 cable, a wireless link, or other communication media known to those of skill in the art. The connection means would comprise an appropriate receptacle for the traveler to connect a wire to the laptop 108. For a wireless system, the traveler would use their own wireless link or one provided by the building while the traveler is visiting. If a non-wireless connection is used, it is usually one wire or multiple wires within one cable but it has a downstream path and an upstream path for communication to and from the laptop 108. This can be achieved through a number of means known to those of skill in the art including frequency multiplexing, time multiplexing, or other means. It is likely that the hotel will have additional equipment such as splitters, joiners, amplifiers, or other network equipment between the connection means 116 and the laptop 108 and the building equipment center 116. It is anticipated that building equipment 112 would service a number of devices such as laptops (not shown) connected in a local area network. This local area network could be a tree and branch network or any other topology known to those of skill in the art.

For someone staying in the building for only a short time, such as a business traveler staying just a night or two in a hotel, it is important to the traveler to be able to connect out to resources via the Internet 200 (or other wide area network) without making a set of technical adjustments to settings for the laptop 108. Making changes to the laptop is beyond the proficiency or comfort zone for most business travelers Even the business travelers that have the skills to make these changes would prefer to avoid spending the time to change the settings and then change them back when they return to their place of employment and wish to connect to the employer's network.

Thus, a traveler does not obtain an email address and email software configured to work with the building equipment center SMTP server. Thus, email from the laptop 108 travels out from the building equipment center 112 to the Internet 200. When this email reaches the equipment at a second building 150 (for this example “traveler's ISP's mail server equipment”), the email is rejected as mail from individual users is not normally accepted when received from the Internet 200. Unlike email from individual users (154, 158) connected directly connected to the mail server equipment via a local area network (LAN), which is accepted. (Element 152 represents the network components that connect the laptops with the equipment 150). The traveler will be able to receive email from other users (154, 158); however, since the traveler's sent email is rejected by the equipment in the second building 150, he/she will not be able to respond to email received from other users (154, 158). The problem of sending email to the ISP's equipment 150 may extend to all the laptop 108's configured email accounts (if more than one), as most ISPs and many corporate email systems are setup in-a similar fashion.

Prior Art Solutions

One solution is for the traveler to use a telephony-based dialup connection to access the fill range of services from their email when traveling. The traveler would need to have a user account and a password to access the dial-up ISP or corporate systems. After an authenticated session is established with the dial-up ISP or corporate office, the use of the dial-up service allows the email to pass through a Point of Presence (POP) for the dial-up ISP. Email passing through dial-up is much like being connected to a LAN with direct access to email services, where a user is deemed a reliable email source.

The use of a dial-up ISP is not desirable, as the bandwidth offered by these dialup connections cannot support many of the services Internet users have become accustom to with broadband access. Many users of laptops have their computers configured to synchronize local copies of folders or files with copies on the network. Thus, a traveler connecting through a slow dial-up connection must either endure a lengthy delays when sending emails with large attachments. The traveler must also endure lengthy delays as the laptop synchronizes a large number of folders with the employer's email servers or the traveler must know how to disable the synchronization for folders not essential for this communication session.

The problem is compounded as the traveler is often not very familiar with the dial-up service that is often the personal or home Internet Service Provider. The home account for the dial-up ISP may be used nearly exclusively by the children of the traveler or the traveler's stay at home spouse as the traveler may use the connections to the traveler's employer's network the vast majority of the time.

Even if the traveler is familiar with the use of the dial-up ISP, it is often undesirable to use this connection as it is slow as mentioned above, but it requires inserting the local phone number for the ISP into the modern software, and may require a charge per minute of connection to the ISP through the dial-up connection. The problem is further exacerbated if the building 104 where the traveler is staying imposes heavy charges to the phone call to the ISP.

Another prior art solution is to equip the laptop 108 and the equipment at the employer's equipment 150 to support a virtual private network (VPN) connection. Part of the process of establishing a VPN session calls for passing information to authorize the connection. Once connected, the remote employee (or traveling employee) could be provided with access to the resources at the employer's building as if the employee was at the building. This solution is suitable for some traveling employees but many employers do not expend the resources to support VPN connections.

An objective of this invention is to provide method for successfully sending email from a user's computer, when that computer is not directly connected to the user's Internet Service Provider (ISP).

A further objective of this invention is to provide a means for re-routing outgoing email from a user's computer without requiring the user to modify the settings of the computer.

### BRIEF SUMMARY OF DISCLOSURE

The present invention is directed to a method for routing email communications so that they will be received by email servers. This allows a user (often a traveler) to send emails even when not connected to the user's normal ISP (Internet Service Provider) either directly or through an authorized access points (AAPs) or points of presence (POPs). If implemented at a hotel, the method comprises identifying the outgoing communication as an email before it reaches the wide area network (such as the Internet) and routing the outgoing communication through an email server affiliated with the hotel's equipment for operating the local area network. The email server accepts the email from the hotel's local area network equipment and routes the data communication to its original addressee either directly or through a proxy sever relationship with an ISP. After the email is re-routed, the data communication bears identifying information that it was transmitted from the email server or the ISP (if the proxy server mode was used). This identifying information allows the data communication to be accepted at the email server handling email for the original email address on the outgoing communication.

These and other advantages of the present invention are apparent from the drawings and the detailed description that follows.

### BRIEF DESCRIPTION OF THE DRAWINGS

FIG. 1 shows the prior art and illustrates that laptop 108 for a visiting user is able to receive email from laptop 154 or 158 but cannot send email to those laptops.

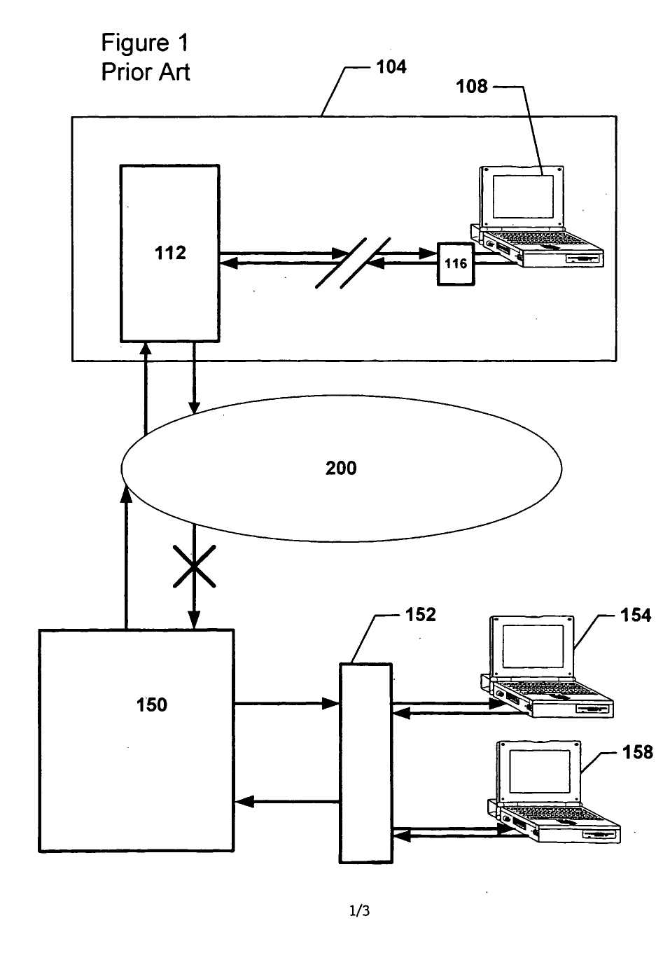

FIG. 2 shows a first embodiment of the present invention where the affiliated email server 304 is local to the local area network equipment.

FIG. 3 shows a second embodiment of the present invention where the affiliated email server 304 is remote from the building equipment and is accessed across a wide area network.

### DETAILED DESCRIPTION OF THE DISCLOSED EMBODIMENTS

The present invention will now be described more fully hereinafter with reference to the accompanying drawings, in which preferred embodiments of the invention are shown.

This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

A solution to this problem is to provide a specialized service that will forward all out-going email traffic from users at a location to a specified SMTP service, regardless of how a user's email program has been configured to send email. Thus, the building equipment 112 is modified to route all outbound email through a SMTP server 304 located in the same building as the building equipment 112. Those of skill in the art can appreciate that the functions of the SMTP server 304 can be placed within a separate component in data communication with the existing building equipment 112 or can be incorporated into the existing building equipment. (collectively 305).

This can be accomplished by monitoring all SMTP TCP/IP packets (generally Port 25; but any port number could be used) directed through a gateway or routing device, and modify those packets such that they are forwarded to a specific SMTP service 304.

This SMTP server 304 is configured to accept incoming email messages from any standard email client software configured for any SMTP server; with or without authentication of the sending user. Thus the traveler does not need to change any email software settings to utilize the system.

The SMTP server 304 can then be optionally stored and then forward those messages to the appropriate service provider for delivery (such as to building equipment 150 if addressed to an employee of that employer). Storing email would be useful at locations with congested or limited bandwidth connection, minimizing user sending delay; however it is suggested that email be sent with delivery notifications to verify email deliveries. The service can deliver messages two ways: direct delivery (via configuration methods known to those skilled in the art), or as a proxy. As a SMTP proxy, the SMTP server 304 would connect to an ISPs mail service 308 as if it were a user's email client and pass all captured out-going email message through a user account associated with this proxy service This email destined for laptop 154 would pass through SMTP server 304 and ISP 308 before employer's equipment 150 if SMTP server 304 is operating in proxy mode. While this could be accomplished by a dial-up connection to the ISP 308, the preferred method would be a high speed connection through the Internet 200.

When operated in direct delivery mode, the traveler can send an email to an email user (not shown) serviced by ISP (308) from laptop 108 through the building center equipment 112 which reroutes the email to SMTP server 304 and then routes it to ISP 308 to reach the user of ISP 308. This direct delivery will work without any special relationship between SMTP server 304 and ISP 308. Likewise the traveler can send email to laptop 154 without ISP 308 as the email will be routed from SMTP server 304 to employer's equipment 150.

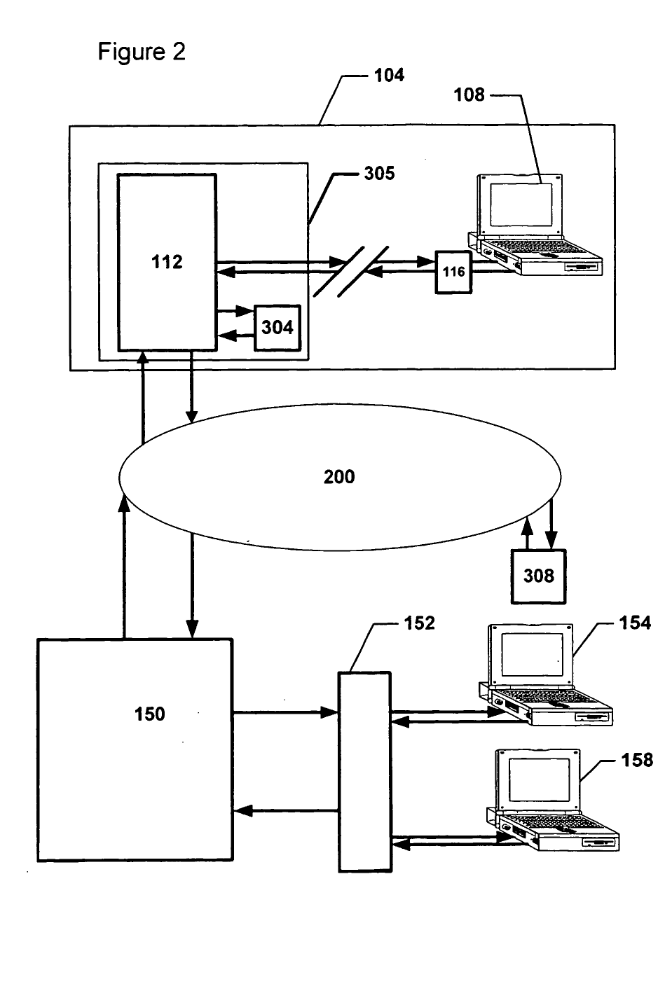

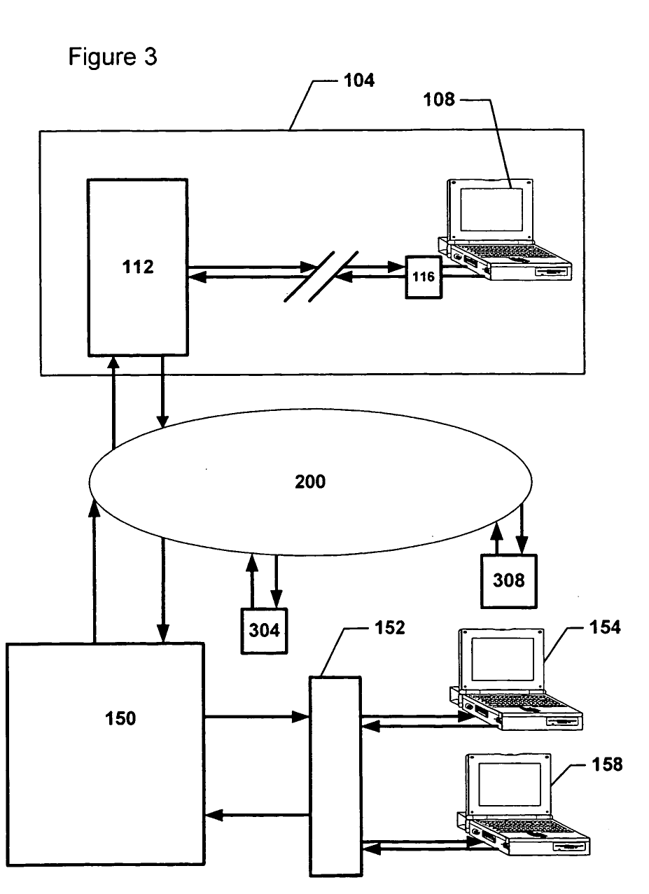

The SMTP forwarding service and its related components can reside at the user's physical location as shown in FIG. 2 or these components may be distributed between the user's location and any other convenient locations that are Internet access enabled. FIG. 3 shows the SMTP server 304 located outside of building 104 and independently connected to the Internet 200. Thus, an email message from the traveler using laptop 108 would travel through the building equipment 112 at the hotel where it would be identified as outgoing email. The outgoing email would be re-routed across the Internet 200 to a SMTP server 304, where it will be sent to the appropriate recipient(s), based on their domain names. Thus back across the Internet 200 to a subscriber's ISP 308 or employer's equipment 150 and eventually to a co-worker working on laptop 154. This SMTP server 304 would configured to only accept email from the building equipment 112 by utilizing its MAC address or other form of authentication; and then optionally store emails, and then utilize standard practices and conventions in delivering email to the designated recipient(s).

Those of skill in the art will recognize that the SMTP server 304 could be located within building 104 and for some reason be connected to the building equipment 112 solely through a wide area network 200. (this configuration is not shown in the drawings) The end result of the SMTP forwarding service is that Internet users can connect to the Internet and send and receive email from any location supporting this service without directly connecting to their ISP or reconfiguring some aspect of their computer to accommodate the current location.

The example given above is for a traveling employee at a hotel sending email to the employee's co-worker. This detail helps explain the context and industrial applicability of the invention but the principles apply to any traveling user. Thus, a college student or a retiree that moves from one location to another would benefit from the ability to send SMTP messages that are accepted rather than rejected as coming from an unknown source.

While SMTP is the most common protocol for sending email messages that would benefit from the current invention, the invention does not rely on the SMTP protocol. Data communications of other protocols that can be readily identified as email communications can likewise be routed to an email server capable of carrying that protocol and passing it through another device connected to a wide area network so that the email is accepted by other email servers on the wide area network because the email is marked as having been placed on the wide area network (such as the Internet) by a known and trusted device.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent.

Glossary of Abbreviations

| | |
|---|---|
| ISP | Internet Service Provider |
| IP | Internet Protocol |
| POP | Point of Presence |
| AAP | Authorized Access Point |
| SMTP | Simple Mail Transfer Protocol |
| TCP | Transfer Control Protocol |
| DNS | Domain Name Service |
| MAC | Media Access Control |

1. A method of routing a data communication from a first device connected to a first local network to an email address serviced by a target email server, not on the first local network, wherein both the first local network and the target email server have their own connections to a common network, the method comprising:
Equipment for the first local network receiving a first data communication from the first device connected to a first local network,
Equipment for the first local network discerning that the received first data communication is an email;
After discerning that the received data communication is an email, equipment for the first local network routing the first data communication to an affiliated email server, different from the target email server;
The affiliated email server receiving the data communication without requiring an independent authorization routine with the first device; and
The affiliated email server passing the data communication to the targeted email server, the data communication containing identifying information associated with the affiliated email server so that the data communication will be accepted by the targeted email server.

2. The method of claim 1 wherein the step of discerning that the first data communication is an email comprises comparing the port associated with the data communication with a set of at least one port associated with email communications.

3. The method of claim 1 wherein all outbound data communications with a particular port number are routed to the affiliated email server.

4. The method of claim 1 wherein all outbound SMTP data communications are routed to the affiliated email server, independent of the port number associated with each the data communication.

5. The method of claim 1 wherein the data communications routed to the affiliated email server reach the affiliated email server without traversing any part of the common network.

6. The method of claim 1 wherein the affiliated server is integrated into the equipment for the first local network.

7. The method of claim 1 wherein the affiliated server is connected to the equipment for the first local network through the common network.

8. The method of claim 1 where the affiliated email server is configured to only accept email communications from the equipment for the first local network.

9. The method of claim 1 where the affiliated email server is configured to store the data communications routed to the affiliated server before passing the data communication to the targeted email server.

10. A method of routing a data communication from a first device connected to a first local network to an email address serviced by a target email server, not on the first local network, wherein both the first local network and the target email server have their own connections to a common network, the method comprising:
Equipment for the first local network receiving a first data communication from the first device connected to a first local network,
Equipment for the first local network discerning that the received first data communication is an email;
After discerning that the received data communication is an email, equipment for the first local network routing the first data communication to an affiliated email server, different from the target email server;
The affiliated email server receiving the data communication without requiring an independent authorization routine with the first device; and
The affiliated email server passing the data communication through an Internet Service Provider's equipment to the common network addressed to the email address serviced by the target email server and bearing identifying information associated with the Internet Service Provider equipment.

11. The method of claim 10 wherein the step of discerning that the first data communication is an email comprises comparing the port associated with the data communication with a set of at least one port associated with email communications.

12. The method of claim 10 wherein all outbound data communications with a particular port number are routed to the affiliated email server.

13. The method of claim 10 wherein all outbound SMTP data communications are routed to the affiliated email server, independent of the port number associated with each the data communication.

14. The method of claim 10 wherein the data communications routed to the affiliated email server reach the affiliated email server without traversing any part of the common network.

15. The method of claim 10 wherein the affiliated server is integrated into the equipment for the first local network.

16. The method of claim 10 wherein the affiliated server is connected to the equipment for the first local network through the common network.

17. The method of claim 10 where the affiliated email server is configured to only accept email communications from the equipment for the first local network.

18. The method of claim 10 where the affiliated email server is configured to store the data communications routed to the affiliated server before passing the data communication to the targeted email server.

19. The invention as described and illustrated in the specification and referenced figures.
